(19) United States
(12) Patent Application Publication
(10) Pub. No.: US 2025/0363789 A1
(43) Pub. Date: Nov. 27, 2025

(54) PORTRAIT GENERATION METHOD, APPARATUS, AND DEVICE

(71) Applicant: Smarter Silicon (Shanghai) Technologies Co., Ltd., Shanghai (CN)

(72) Inventor: Haihan WANG, Shanghai (CN)

(21) Appl. No.: 19/216,691

(22) Filed: May 22, 2025

(30) Foreign Application Priority Data
May 24, 2024 (CN) 202410660710.0

(51) Int. Cl. G06V 10/80; G06T 5/70

(52) U.S. Cl. CPC G06V 10/806; G06T 5/70; G06T 2207/20081

(57) ABSTRACT

A portrait generation method includes obtaining an original portrait image and target style information for the original portrait image, and performing identity feature extraction on the original portrait image using a preset portrait generation model to obtain identity feature information, and performing a plurality of denoising processes on an initial noise image based on the identity feature information and the target style information to generate a target portrait image.

### CROSS-REFERENCE TO RELATED APPLICATION

The present disclosure claims priority to Chinese Patent Application No. 202410660710.0, filed on May 24, 2024, the entire content of which is incorporated herein by reference.

### TECHNICAL FIELD

The present disclosure is related to the image processing technology field and, more particularly, to a portrait generation method, a portrait generation apparatus, and a portrait generation device.

### BACKGROUND

Deep learning-based generative models have attracted increasing attention and are being widely applied. Artificial intelligence (AI) generative models have achieved good results in portrait generation in the field of portrait photography. In text-to-image methods, due to the lack of prior knowledge about the user appearance, images with similar human faces are difficult to generate. Although a face-swapping method ensures human face similarity, the generated image does not appear natural.

### SUMMARY

An aspect of the present disclosure provides a portrait generation method. The method includes obtaining an original portrait image and target style information for the original portrait image, and performing identity feature extraction on the original portrait image using a preset portrait generation model to obtain identity feature information, and performing a plurality of denoising processes on an initial noise image based on the identity feature information and the target style information to generate a target portrait image.

An aspect of the present disclosure provides a portrait generation apparatus, including an acquisition module and a processing module. The acquisition module is configured to obtain an original portrait image and target style information for the original portrait image. The processing module is configured to perform identity feature extraction on the original portrait image using a preset portrait generation model to obtain identity feature information, and perform a plurality of denoising processes on an initial noise image based on the identity feature information and the target style information to generate a target portrait image.

An aspect of the present disclosure provides a portrait generation device, including one or more processors, one or more memories, and a communication bus. The one or more memories store a computer program that, when executed by the one or more processors, causes the one or more processors to obtain an original portrait image and target style information for the original portrait image, perform identity feature extraction on the original portrait image using a preset portrait generation model to obtain identity feature information, and perform a plurality of denoising processes on an initial noise image based on the identity feature information and the target style information to generate a target portrait image. The communication bus is configured to realize a communicative connection between the one or more processors and the one or more memories.

### BRIEF DESCRIPTION OF THE DRAWINGS

FIG. 1 illustrates a schematic flowchart of a portrait generation method according to some embodiments of the present disclosure.

FIG. 2 illustrates a schematic structural diagram of an identity feature extraction network according to some embodiments of the present disclosure.

FIG. 3 illustrates a schematic flowchart of a noise reduction processing method according to some embodiments of the present disclosure.

FIG. 4 illustrates a schematic structural diagram of a predetermined portrait generation model according to some embodiments of the present disclosure.

FIG. 5 illustrates a schematic structural diagram of an identity feature fusion network according to some embodiments of the present disclosure.

FIG. 6 illustrates a schematic flowchart of model training according to some embodiments of the present disclosure.

FIG. 7 illustrates a schematic structural diagram of a model during training according to some embodiments of the present disclosure.

FIG. 8 illustrates a schematic flowchart of model training according to some embodiments of the present disclosure.

FIG. 9 illustrates a schematic flowchart of determining total loss information according to some embodiments of the present disclosure.

FIG. 10 illustrates a schematic flowchart of determining identity loss information according to some embodiments of the present disclosure.

FIG. 11 illustrates a schematic flowchart of determining style loss information according to some embodiments of the present disclosure.

FIG. 12 illustrates a schematic flowchart of determining total loss information according to some embodiments of the present disclosure.

FIG. 13 illustrates a schematic structural diagram of a portrait generation apparatus according to some embodiments of the present disclosure.

FIG. 14 illustrates a schematic structural diagram of a portrait generation device according to some embodiments of the present disclosure.

### DETAILED DESCRIPTION OF THE EMBODIMENTS

The technical solutions of the present disclosure are described in detail in connection with the accompanying drawings of embodiments of the present disclosure. The embodiments described are merely used to explain, not limit the present disclosure. Moreover, to facilitate description, the accompanying drawings only show portions related to the present disclosure.

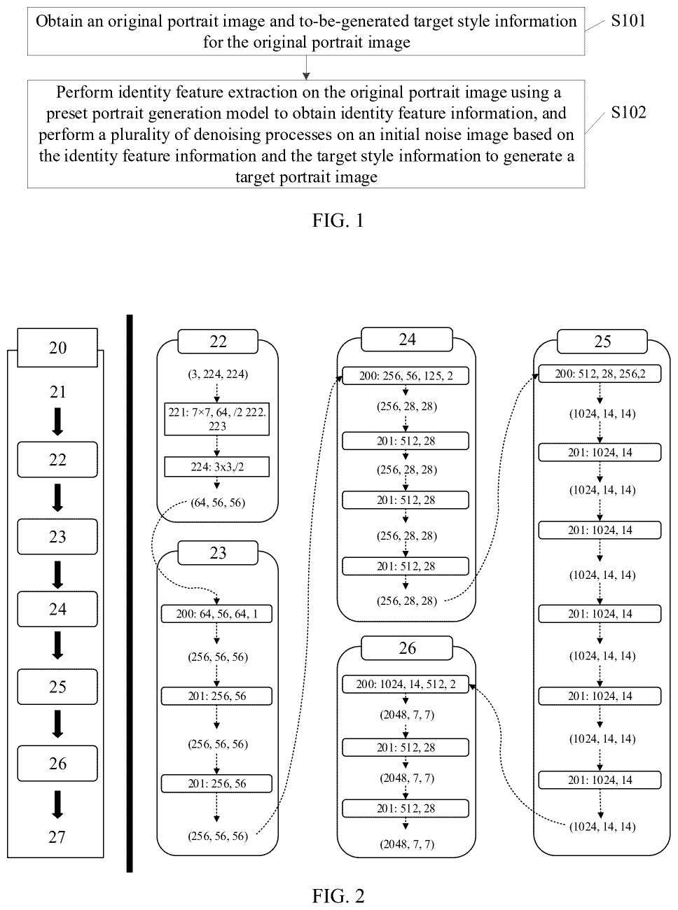

Embodiments of the present disclosure provide a portrait generation method implemented by a portrait generation device. As shown in FIG. 1, the method includes the following processes S101 and S102.

At S101, an original portrait image and to-be-generated target style information for the original portrait image are obtained.

In embodiments of the present disclosure, the portrait generation device can be an electronic device with a portrait generation function, such as a tablet computer, laptop, handheld computer, personal digital assistant (PDA), desktop computer, etc., which is not limited here.

In embodiments of the present disclosure, the original portrait image can be a human image that is to be processed for portrait generation. The target style information is style information that needs to be generated for the person in the original portrait image. For example, the target style information can include style information such as uniform or academic fashion.

In embodiments of the present disclosure, the portrait generation device can directly obtain the original portrait image and the to-be-generated target style information for the original portrait image.

For example, the portrait generation device can obtain the original portrait image from a locally stored image collection of the portrait generation device, which is captured through a camera, or from networks. The specific acquisition method can be set according to actual application and scenario requirements, which is not limited in the present disclosure. The method for the portrait generation device to obtain the to-be-generated target style information for the original portrait image can include providing a plurality of kinds of style information by the portrait generation device for the user to select, determining the style information selected by the user as the target style information, self-setting the style information based on the original portrait image, or directly inputting the wanted style information by the user. The acquisition method can be determined according to the practical application and scenario requirements, which is not limited.

At S102, a preset portrait generation model is configured to extract identity features from the original portrait image to obtain identity feature information and then perform a plurality of denoising processes on an initial noise image based on the identity feature information and target style information to generate a target portrait image.

In embodiments of the present disclosure, after obtaining the original portrait image and target style information, the portrait generation device can be configured to extract the identity features from the original portrait image using the preset portrait generation model to obtain the identity feature information, and perform the plurality of denoising processes on the initial noise image based on the identity feature information and target style information to generate the target portrait image. The portrait style of the target portrait image can be the style represented by the target style information.

In embodiments of the present disclosure, the preset portrait generation model can include an identity feature extraction network for extracting identity features from the original portrait image to obtain the identity feature information. For example, the identity feature extraction network can include a face recognition network, which can be an ArcFace network 20 based on ResNet50. As shown in FIG. 2, the ArcFace network 20 mainly includes an input 21, stage0 22, stage1 23, stage2 24, stage3 25, stage4 26, and an output 27. Stage0 22 can be an input (3, 224, 224) through 64 convolutional kernels (CONV) 221 with a size of (7, 7) and a step size of 2, followed by a batch normalization layer (BN) 222 and an activation layer (RELU) 223, and subsequently through a max pooling layer (MAXPOOL) 224 with a kernel size of (3×3) and a step size of 2. Stage1 23, Stage2 24, Stage3 25, and Stage4 26 are consist of BINK1 200 and BINK2 201. BINK1 includes four parameters, e.g., input channel number C, input size W (length and width), convolutional layer output channel number C1, and step size of the convolutional layer S. BINK2 includes two parameters, e.g., input channel number C and input size W (length and width).

For example, the preset portrait generation model can be implemented based on a diffusion model. The diffusion model can be configured to perform the plurality of denoising processes on the initial noise image based on the target style information. The initial noise image can be a random noise image, such as Gaussian noise.

Compared to the existing related technologies, which suffer from issues such as dissimilar facial features or poor image naturalness, in the present disclosure, the identity features can be extracted from the original portrait image, and the denoising processes can be performed on the initial noise image based on the identity feature information and target style information to generate the target portrait image having the consistent facial appearance with the original portrait image and automatically transferring the target style information. Thus, the portrait generation quality can be improved.

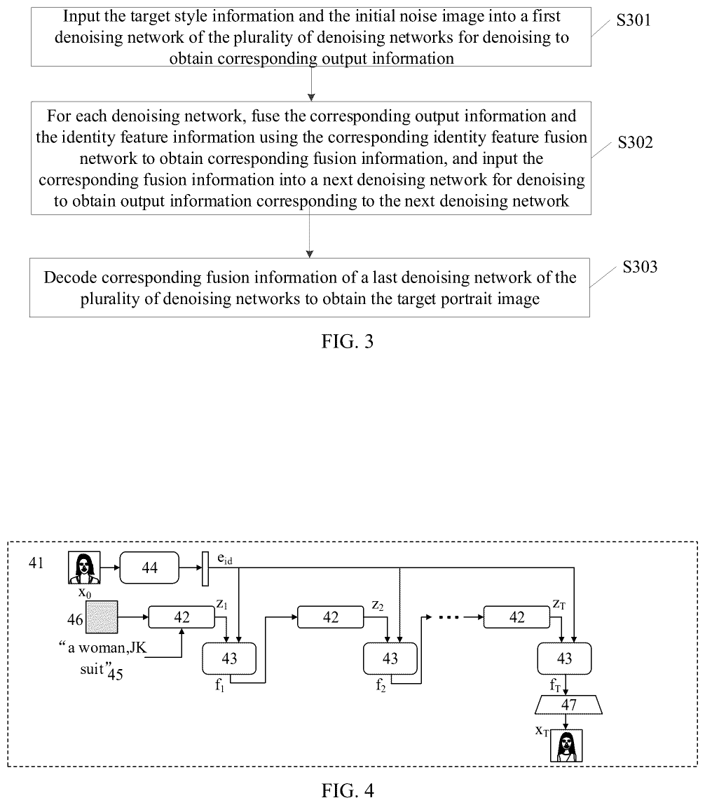

In some embodiments, the preset portrait generation model can include a plurality of layers of denoising networks that are sequentially connected. Each layer of denoising networks can be connected to a corresponding identity feature fusion network. As shown in FIG. 3, step S102 of performing the plurality of denoising processes on the target style information based on the identity feature information to generate the target portrait image performed by the portrait generation device includes processes S301 to S303.

At S301, the target style information and the initial noise image are input into a first denoising network of the plurality of denoising networks for denoising to obtain corresponding output information.

In embodiments of the present disclosure, the portrait generation device can input the target style information and initial noise image into the first denoising network of the plurality of denoising networks that are sequentially connected and included in the preset portrait generation model for denoising to obtain the corresponding output information. Each denoising network of the plurality of denoising networks can be a Unet network.

For example, the input target style information can be a female high school student wearing a school suit (a women, JK suit).

At S302, for each denoising network, the corresponding identity feature fusion network is configured to fuse the corresponding output information and the identity feature information to obtain corresponding fusion information and input the corresponding fusion information into a next denoising network for denoising to obtain output information corresponding to the next denoising network.

In embodiments of the present disclosure, for each denoising network, the portrait generation device can be configured to fuse the corresponding output information and the identity feature information using the corresponding identity feature fusion network to obtain the fusion information and input the fusion information to the next denoising network to continue with the denoising process. Thus, after each denoising network performs the fusion process on the corresponding output information and the identity feature information to obtain the fusion information, the fusion information can be input to the next denoising network to ensure portrait consistency.

At step S303, a decoding process is performed on the fusion information corresponding to the last denoising network of the plurality of denoising networks to obtain the target portrait image.

In embodiments of the present disclosure, the portrait generation device can be configured to decode the fusion information corresponding to the last denoising network of the plurality of denoising networks to obtain the target portrait image.

As shown in FIG. 4, an exemplary preset portrait generation model 41 is provided. The preset portrait generation model 41 includes a plurality of denoising networks 42 that are sequentially connected. Each denoising network 42 is connected to a corresponding identity feature fusion network 43. The preset portrait generation model 41 further includes an identity feature extraction network 44 shown in FIG. 2. The identity feature extraction network 44 can be configured to extract the identity feature information from the input original portrait image x₀ to obtain identity feature information e_{id}. The portrait generation device can be configured to input the target style information 45 and the initial noise image 46 into the first denoising network 42 of the plurality of denoising networks 42 for denoising to obtain the corresponding output information zᵢ. For each denoising network 42, the portrait generation device can be configured to fuse the corresponding output information zᵢ and the identity feature information e_{id} using the corresponding identity feature fusion network 43 to obtain the corresponding fusion information fi and input the corresponding fusion information fᵢ into the next denoising network 42 for denoising to obtain the output information fᵢ₊₁ corresponding to the next denoising network 42. The preset portrait generation model 41 can further include a decoder 47 configured to decode the fusion information f_{T} corresponding to the last denoising network 42 of the plurality of denoising networks 42 to obtain the target portrait image x_{T}. Thus, the fusion information fᵢ can be combined with the information of the original portrait image to allow the obtained target portrait image to maintain the facial consistency. For example, the preset portrait generation model can be obtained by training based on the diffusion model. The plurality of denoising networks 42 can be the Unet network included in the diffusion model.

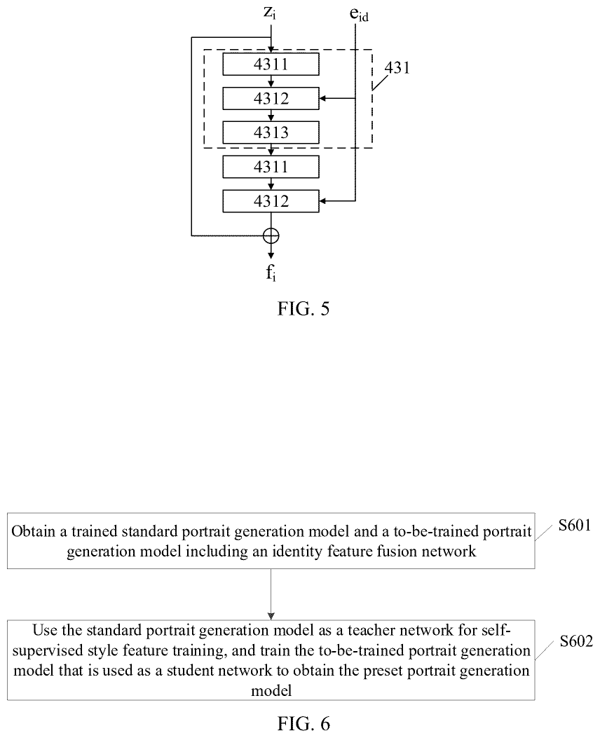

In some embodiments, the identity feature fusion network can include a plurality of fusion units that are sequentially connected. As shown in FIG. 5, step S302 of, for each denoising network, fusing the corresponding output information and the identity feature information to obtain the corresponding fusion information by the corresponding identity feature fusion network performed by the portrait generation device includes the following processes. For each denoising network, fusion can be performed on the corresponding output information and the identity feature information for a plurality of times by the plurality of corresponding fusion units to obtain the corresponding fusion information. The input to the first fusion unit of the plurality of fusion units can be the output information of the corresponding denoising network. The output of each fusion unit and the identity feature information can be used as the input for the next fusion unit.

In embodiments of the present disclosure, the identity feature fusion network can include the plurality of sequentially connected fusion units. For each denoising network, the portrait generation device can be configured to perform a plurality of times of fusion on the corresponding input information and the identity feature information using the plurality of corresponding fusion units to obtain the corresponding fusion information. The input of the first fusion unit of the plurality of fusion units can be the output information of the corresponding denoising network. Then, the output of each fusion unit and the identity feature information can be used as the input of the next fusion unit.

As shown in FIG. 5, an exemplary network structural diagram of the identity feature fusion network 43 is provided. The identity feature fusion network 43 includes at least one fusion unit 431. Each fusion unit 431 includes a convolutional layer 4311, a style transfer network 4312, and an activation layer 4313. For example, the style transfer network 4312 can include a style transfer algorithm (Adaptive Instance Normalization, AdaIN). The style transfer algorithm is implemented by Formula (1):

$$AdaIN ( {z}_{i} , {e}_{i d} ) = {σ}_{{e}_{id}} \frac{{z}_{i} - μ ( {z}_{i} )}{σ ( {z}_{i} )} + {μ}_{{e}_{id}} \qquad ( 1 )$$

where, zᵢ denotes output information, e_{id} denotes the identity feature information, Gₑid denotes the variance of the identity feature information e_{id}, σ(zᵢ) denotes the variance of the output information zᵢ, μ(zᵢ) denotes the mean of the output information zᵢ, and μ_{eid} denotes the mean of the identity feature information e_{id}.

In some embodiments, as shown in FIG. 6, the portrait generation device is also configured to perform processes S601 and S602.

At S601, a pre-trained standard portrait generation model and a to-be-trained portrait generation model that includes an identity feature fusion network are obtained.

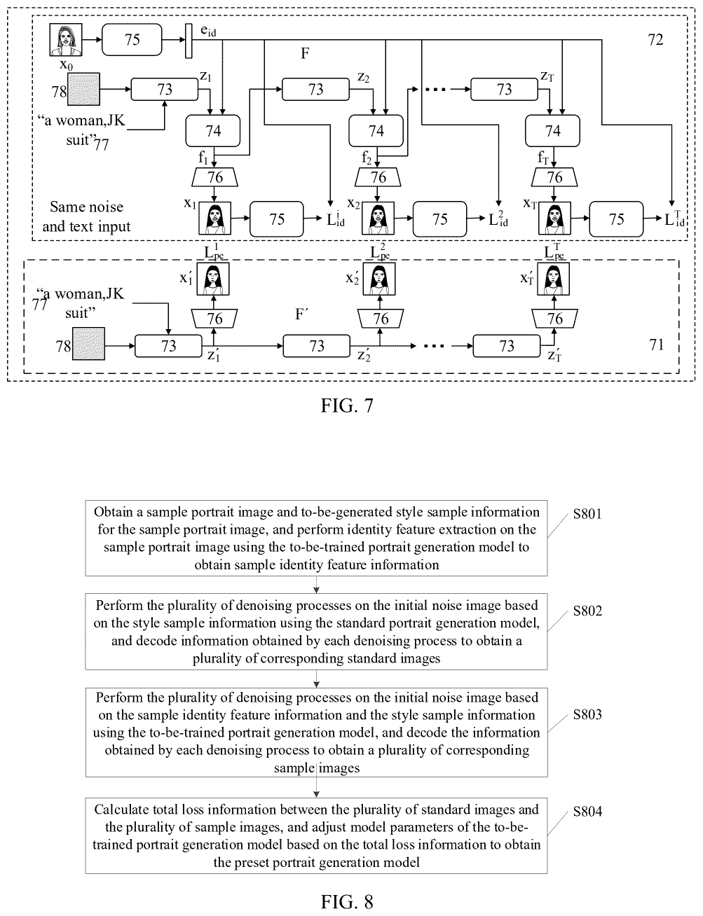

In embodiments of the present disclosure, the portrait generation device can be configured to obtain the pre-trained standard portrait generation model and the to-be-trained portrait generation model that includes the identity feature fusion network. For example, the to-be-trained portrait generation model can be a direct copy of the network structure of the pre-trained standard portrait generation model. The pre-trained standard portrait generation model can be a network based on the diffusion model. The to-be-trained portrait generation model can be consistent with the network structure and network parameters of the pre-trained standard portrait generation model involved with the diffusion model. For example, as shown in FIG. 7, the trained standard portrait generation model 71 and the to-be-trained portrait generation model 72 including the identity feature fusion network are provided. The to-be-trained portrait generation model is consistent with a portion of the network structure of the preset portrait generation model in FIG. 4, but with different network parameters. The to-be-trained portrait generation model includes the plurality of denoising networks 73 that are sequentially connected, a corresponding identity feature fusion network 74 connected to each denoising network 73, and the identity feature extraction network 75 shown in FIG. 2. Then, the fusion information output by the identity feature fusion network 74 corresponding to each denoising network 73 can be input to the decoder 76, and the identity feature extraction network 75 is connected after the decoder 76. The trained standard portrait generation model includes the plurality of sequentially connected denoising networks 73. Each denoising network 73 of the plurality of denoising networks 73 is connected to a decoder 76.

At S602, the standard portrait generation model is used as a teacher network for self-supervised style feature training to train the to-be-trained portrait generation model that is used as a student network to obtain the preset portrait generation model.

In embodiments of the present disclosure, as shown in FIGS. 4 and 7, the portrait generation device can use the standard portrait generation model 71 as the teacher network for self-supervised style feature training to train the to-be-trained portrait generation model 72 that is used as the student network to obtain the preset portrait generation model 41. Thus, the to-be-trained portrait generation model can be fine-tuned in a self-supervised manner to allow the model to adapt to different style transfer features.

In some embodiments, as shown in FIG. 8, step S602 performed by the portrait generation device can also include processes S801 to S804.

At S801, a portrait sample image and style sample information to be generated for the portrait sample image are obtained. Then, the to-be-trained portrait generation model is configured to extract identity features from the portrait sample image to obtain sample identity feature information.

In embodiments of the present disclosure, the portrait generation device can be configured to obtain the portrait sample image and the style sample information to be generated for the portrait sample image to input the portrait sample image into the identity feature extraction network included in the to-be-trained portrait generation model to extract the identity features to obtain the sample identity feature information.

As shown in FIG. 7, the portrait generation device is configured to input the portrait sample image into the identity feature extraction network 75 of the to-be-trained portrait generation model to extract the identity features to obtain the sample identity feature information.

At S802, the standard portrait generation model is configured to perform the plurality of denoising processes on the initial noise image based on the style sample information and decode the information obtained from each denoising process to generate a plurality of corresponding standard images.

In embodiments of the present disclosure, the portrait generation device can be configured to perform the plurality of denoising processes on the style sample information using the standard portrait generation model and decode the information obtained by each denoising process to obtain the plurality of corresponding standard images. For example, as shown in FIG. 7, the portrait generation device is configured to perform the plurality of denoising processes on the initial noise image 78 based on the style sample information 77 (the style sample information in the training stage, and the target style information in the reference stage) using the plurality of denoising networks 73 included in the standard portrait generation model, and decode the information obtained by each denoising process to obtain the plurality of corresponding standard images xᵢ′.

At S803, the to-be-trained portrait generation model is configured to perform the plurality of denoising processes on the initial noise image based on the sample identity feature information and the style sample information, and decode the information obtained by each denoising process to generate the plurality of corresponding sample images.

In embodiments of the present disclosure, the portrait generation device can be configured to perform the plurality of denoising processes on the style sample information based on the sample identity feature information using the to-be-trained portrait generation model and decode he information obtained by each denoising process to obtain the plurality of corresponding sample images. For example, as shown in FIG. 7, the portrait generation device is configured to input the style sample information 77 and the initial noise image 78 into the plurality of denoising networks 73 to perform the plurality of denoising processes on the initial noise image 78, fuse the information obtained by each denoising process and the sample identity feature information using the identity feature fusion network 74 corresponding to each denoising network 73, and input the fusion information into the corresponding decoder 76 to obtain the corresponding sample image xᵢ to obtain the plurality of sample images.

At S804, total loss information between the plurality of standard images and the plurality of sample images are calculated, and the model parameters of the to-be-trained portrait generation model are adjusted based on the total loss information to obtain the preset portrait generation model.

In embodiments of the present disclosure, after obtaining the plurality of standard images and plurality of sample images, the portrait generation device can be configured to calculate the corresponding total loss information based on the plurality of standard images and the plurality of sample images, and adjust the model parameters of the to-be-trained portrait generation model based on the total loss information to obtain the preset portrait generation model.

In embodiments of the present disclosure, training is performed based on FIG. 7. After adjusting the model parameters of the to-be-trained portrait generation model 72, the preset portrait generation model shown in FIG. 4 is obtained. During inference, the preset portrait generation model can be obtained by removing the decoders 76 and identity feature extraction networks 75 after the plurality of denoising networks in the to-be-trained portrait generation model 72 and retaining only the decoder 76 of the last denoising network.

For example, the preset portrait generation model can be applied in an Artificial Intelligence Generated Content (AIGC) scenario or a text-to-image generation scenario of a large language model.

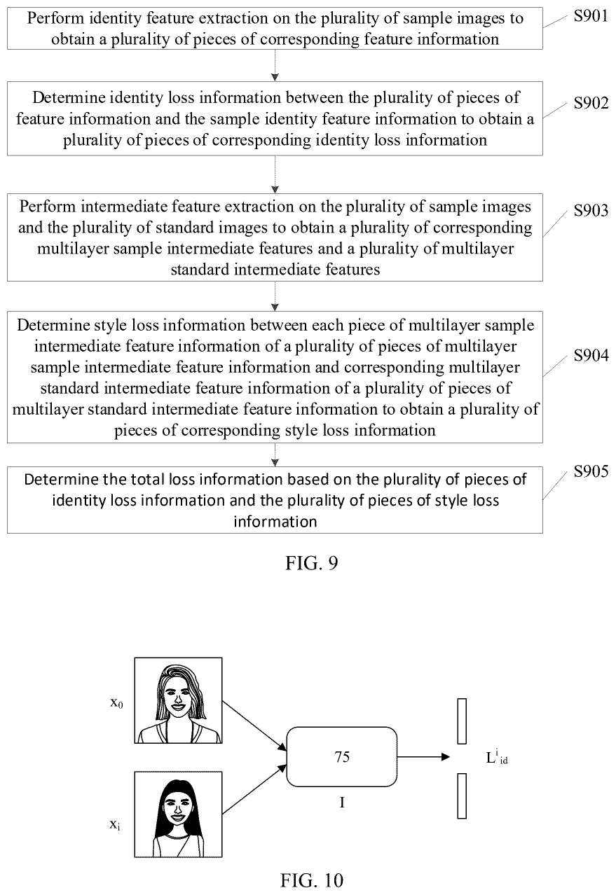

In some embodiments, as shown in FIG. 9, step S804 of calculating the total loss information between the plurality of standard images and the plurality of sample images by the portrait generation device includes processes S901 to S905.

At S901, the identity feature extraction is performed on the plurality of sample images to obtain the plurality of pieces of corresponding feature information.

In embodiments of the present disclosure, the portrait generation device can be configured to perform the identity feature extraction on the plurality of sample images to obtain the plurality of pieces of corresponding feature information. For example, as shown in FIG. 7, the portrait generation device is configured to perform the identity feature extraction on the corresponding decoded sample images using the identity feature extraction network 75 connected after the decoder 76 to obtain the plurality of pieces of corresponding feature information.

At S902, identity loss information between each piece of the plurality of pieces of the feature information and the sample identity feature information is determined to obtain a plurality of pieces of corresponding identity loss information.

In embodiments of the present disclosure, after obtaining the plurality of pieces of feature information, the portrait generation device can be configured to determine the identity loss information between each piece of feature information and the sample identity feature information to obtain the plurality of pieces of corresponding identity loss information. For example, as shown in FIG. 7, the portrait generation device is configured to determine the identity loss information L_{id}ⁱ between each piece of feature information of the plurality of pieces of feature information and the sample identity feature information. FIG. 10 illustrates a schematic flowchart of calculating the identity loss information. To ensure the facial consistency between the image xᵢ generated by the model and the portrait sample image xₛ, the identity feature extraction network I 75 is configured to extract the identity features from the image xᵢ. This feature information should be consistent with the identity feature information (sample identity feature information) of the original portrait image. Thus, the loss function calculation can achieve supervision of the identity feature. For example, the identity feature information can be calculated in formula (2):

$${L}_{id}^{i} = 1 - cos ( I ( {x}_{s} ) - I ( {x}_{i} ) ) \qquad ( 2 )$$

where, L_{id}ⁱ denotes the identity loss information, I(xₛ) denotes the sample identity feature information, and I(xᵢ) denotes an i-th piece of feature information of the plurality of pieces of feature information.

At S903, intermediate feature extraction is performed on the plurality of sample images and the plurality of standard images to obtain a plurality of corresponding multilayer sample intermediate features and a plurality of multilayer standard intermediate features.

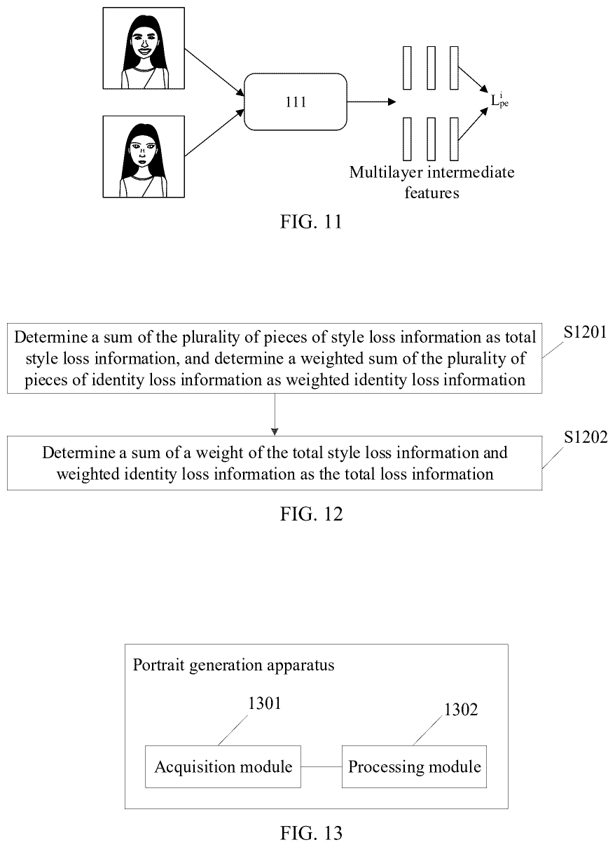

In embodiments of the present disclosure, the portrait generation device can be configured to perform the intermediate feature extraction on the plurality of sample images and the plurality of standard images to obtain the plurality of corresponding multilayer sample intermediate features and the plurality of multilayer standard intermediate features. For example, as shown in FIG. 11, the portrait generation device is configured to perform the intermediate feature exaction on the plurality of sample images and the plurality of standard images using the convolutional neural network VGG111 to obtain the plurality of corresponding multilayer sample intermediate features and the plurality of multilayer standard intermediate features to calculate the style loss information. To ensure the generated image and the network-generated image have a consistent style, the intermediate features are extracted to calculate the style loss information by aligning the intermediate features.

At S904, the style loss information between each piece of multilayer sample intermediate feature information of the plurality of pieces of multilayer sample intermediate feature information and the corresponding multilayer standard intermediate feature information of the plurality of pieces of multilayer standard intermediate feature information is determined to obtain the plurality of pieces of corresponding style loss information.

In embodiments of the present disclosure, after obtaining the plurality of multilayer sample intermediate features and the plurality of multilayer standard intermediate features, the portrait generation device can be configured to determine the style loss information between each piece of multilayer sample intermediate feature information of the plurality of pieces of multilayer sample intermediate feature information and the corresponding multilayer standard intermediate feature information of the plurality of pieces of multilayer standard intermediate feature information to obtain the plurality of pieces of corresponding style loss information.

For example, the plurality of pieces of style loss information can be calculated in formula (3):

$${L}_{pe}^{i} = {\sum }_{j = 1}^{n} ‖ {p}^{j} ( {x}_{i} ) - {p}^{j} ( {x}_{i}^{′} ) ‖ \qquad ( 3 )$$

where, Lₚₑⁱ denotes the style loss information, n denotes a number of layers of intermediate feature information, p^{j}(xᵢ) denotes j-th layer sample intermediate feature information of i-th multilayer sample intermediate feature information, and pᵢ(xᵢ′) denotes j-th layer standard intermediate feature information of i-th multilayer standard intermediate feature information.

At S905, based on the plurality of pieces of identity loss information and the plurality of pieces of style loss information, the total loss information is determined.

In embodiments of the present disclosure, after determining the plurality of pieces of identity loss information and the plurality of pieces of style loss information, the portrait generation device can be configured to determine the total loss information based on the plurality of pieces of identity loss information and the plurality of pieces of style loss information.

In some embodiments, as shown in FIG. 12, step S905 performed by the portrait generation device further includes processes S1201 and S1202.

At S1201, a sum of the plurality of pieces of style loss information is determined as the total style loss information, and a weighted sum of the plurality of pieces of identity loss information is determined as weighted identity loss information.

In embodiments of the present disclosure, the portrait generation device can be configured to directly determine the sum of the plurality of pieces of style loss information as the total style loss information, and perform weighting on the plurality of pieces of identity loss information to determine the weighted sum of the plurality of pieces of identity loss information as the weighted identity loss information.

At S1202, a sum of the weighted total style loss information and the weighted identity loss information is determined as the total loss information.

In embodiments of the present disclosure, the portrait generation device can be configured to perform weighting on the total style loss information and determine the sum of the weighted total style loss information and the weighted identity loss information as the total loss information.

For example, the total loss information can be determined through formula (4):

$$L = {λ}_{0} {\sum }_{i = 1}^{T} {L}_{pe}^{i} + {\sum }_{i = 1}^{T} {λ}_{i} {L}_{id}^{i} \qquad ( 4 )$$

wherein, λ₀ denotes the weight of the total style loss information, and λᵢ denotes the weight of the i-th piece of identity loss information.

Of course, the same weight can also be used for each identity loss, or each piece of style loss information can be weighted differently, which is determined according to the actual needs and application scenario and is not limited in the present disclosure.

For example, the portrait generation method of the present disclosure can mainly include a training process and an inference process. The training process can include the following processes. First, a diffusion model is pre-trained. As shown in FIG. 7, a backbone network F′ (a standard portrait generation model) consists of T Unets (denoising networks). A text prompt 77 is used as an input, and the Unet network predicts noise for denoising. Thus, the initial noise image 78 is used to gradually generate a portrait image satisfying the text description. Then, the diffusion model network F′ can be copied as F (the to-be-trained portrait generation model). In the training stage, the Unet portion of two networks is frozen and remains unchanged. Same noise and text are input to F′ and F networks. Since the noise predicted in the denoising process has a certain random degree. To ensure F′ and F networks have outputs with a consistent style, random seeds (initial noise) of the two networks are the same. A portrait image x₀ is simultaneously input as the original image (the portrait sample image). The identity features e_{id} are extracted by the identity feature extraction network. The identity feature extraction network is a facial recognition model. Second, for F network, as shown in the upper portion of FIG. 7, the output information zi of each Unet network is connected to an identity feature fusion network. As shown in FIG. 5, the identity feature fusion network is configured to fuse the identity feature e_{id} into zi to obtain fᵢ through an AdaIN module 4312. fᵢ is combined the information of the original portrait image and is used as the input to the next Unet. fᵢ is simultaneously input to the decoder to generate image xᵢ. The same method is applied to all Unet networks of T layers. The output image X_{T} of the Unet network of the last layer is used as the final-generated image. Third, for F′ network, as shown in a lower part of FIG. 7, as the teacher network for self-supervised training, the output zᵢ′ of each Unet network is also connected to a decoder 76 configured to generate the image xᵢ′. The Unet networks remain normal connections. Fourth, to ensure the image xᵢ generated by the F network and the image xᵢ′ generated by the F′ network to have a consistent style content, the denoising process of the F′ network is used as a template to guide the training of the model. As shown in FIG. 11, the image xᵢ and the image xᵢ′ are input to the VGG111 network to extract the intermediate features. By aligning the intermediate features, the sensing loss can be calculated. The style loss function is calculated according to formula (3) to monitor the content features. Fifth, to ensure the faces in the image xᵢ generated by the F network and the original portrait image x₀ be consistent, the identity feature extraction module I (the identity feature extraction network) is configured to extract the identity features from the image xᵢ. The feature should be consistent with the identity feature of the original image. As shown in FIG. 5, the identity loss function is calculated according to formula (2) to monitor the identity feature. Sixth, the total loss function (total loss information) is the weighted sum of the identity feature loss (identity loss information) and the content feature loss (style loss information). For the Unet networks of different layers, the loss between corresponding layers of the F network and F′ network can be calculated based on the content features. The losses between different layers can be directly summed. The losses between outputs of different layers of the F network and the original image can be calculated based on the identity features. The large value difference in the losses of different layers can be weighted and balanced by setting a meta-parameter. Seventh, the above training is completed by using a large number of portrait images of different people and text descriptions of a plurality of styles. Thus, only one training course is needed, and one model fine-adjustment for each person is avoided, which reduces the calculation cost and time cost. The inference process can include the following processes. Only the identity feature extraction module and the F network (the preset portrait generation model) are retained. The portrait image x₀ is input as a portrait reference. The text is input to represent different styles. T denoising processes are performed through the F network. The output x_{T} of the decoder of the last layer is used as the final-generated image (the target portrait image). Thus, the naturalness of the generated image may not be affected by the post-processing. The whole generation process from end to end is realized, and the quality of the generation image is improved.

Embodiments of the present disclosure provide a portrait generation method. The method can include obtaining the original portrait image and the to-be-generated target style information for the original portrait image, performing the identity feature extraction on the original portrait image using the preset portrait generation model to obtain the identity feature information, and perform a plurality of denoising processes on the target style information based on the identity feature information to generate the target portrait image. In the portrait generation method of the present disclosure, the identity features can be extracted from the original portrait image, and the denoising process can be performed on the target style information based on the identity feature information to generate the target portrait image having the consistent facial appearance as the original portrait image and automatically transferring target style information. The quality of the portrait generation can be improved.

Embodiments of the present disclosure provide a portrait generation apparatus, as shown in FIG. 13, including an acquisition module 1301 and a processing module 1302.

The acquisition module 1301 can be configured to obtain the original portrait image and the to-be-generated target style information for the original portrait image.

The processing module 1302 can be configured to extract the identity features from the original portrait image using the preset portrait generation model to obtain identity feature information, and perform the plurality of denoising processes on the target style information based on the identity feature information to generate the target portrait image.

In embodiments of the present disclosure, the preset portrait generation model can include a plurality of sequentially connected denoising networks. Each denoising network can be connected to a corresponding identity feature fusion network. The processing module 1302 can be further configured to input the target style information into the first denoising network of the plurality of denoising networks for denoising to obtain the corresponding output information, for each denoising network, fuse the corresponding output information and the identity feature information using the corresponding identity feature fusion network to obtain the corresponding fusion information, input the corresponding fusion information to the next denoising network for denoising to obtain the output information corresponding to the next denoising network, decode the corresponding fusion information of the last denoising network of the plurality of denoising networks to obtain the target portrait image.

In embodiments of the present disclosure, the identity feature fusion network can include the plurality of fusion units connected in sequence. The processing module 1302 can be further configured to, for each denoising network, perform fusion on the corresponding output information and the identity feature information multiple times by using the plurality of corresponding fusion units to obtain the corresponding fusion information. The input of the first fusion unit of the plurality of fusion units can be the output information of the corresponding denoising network. The output of each fusion unit and the identity feature information can be used as the input for the next fusion unit.

In embodiments of the present disclosure, the preset portrait generation model can be used as the teach network for self-supervised style feature training based on the trained standard portrait generation model. The to-be-trained portrait generation model including the identity feature fusion network can be used as the student network and trained. The plurality of denoising processes can be performed on the initial noise image by using the standard portrait generation model based on the style sample information. The information obtained by each denoising process can be decoded to obtain the plurality of corresponding standard images. The plurality of denoising processes can be performed on the initial noise image by using the to-be-trained portrait generation model based on the sample identity feature information and the style sample information. The information obtained by each denoising process can be decoded to obtain the plurality of corresponding sample images. The total loss information between the plurality of standard images and the plurality of sample images can be calculated. The model parameters of the to-be-trained portrait generation model can be adjusted based on the total loss information to obtain the preset portrait generation model.

In embodiments of the present disclosure, the total loss information can be determined based on the plurality of standard images and the plurality of sample images. The identity feature extraction can be performed on the plurality of sample images to obtain the plurality of pieces of corresponding feature information. The identity loss information between the plurality of pieces of feature information and the sample identity feature information can be determined to obtain the plurality of pieces of corresponding identity loss information. The intermediate feature extraction can be performed on the plurality of sample images and the plurality of standard images to obtain the plurality of corresponding multilayer sample intermediate features and the plurality of multilayer standard intermediate features. The style loss information between each piece of multilayer sample intermediate feature information of the plurality of pieces of multilayer sample intermediate feature information and the corresponding multilayer standard intermediate feature information of the plurality of pieces of multilayer standard intermediate feature information can be determined to obtain the plurality of pieces of corresponding style loss information. The total loss information can be determined based on the plurality of pieces of identity loss information and the plurality of pieces of style loss information.

In embodiments of the present disclosure, the total loss information can be determined based on the plurality of pieces of identity loss information and the plurality of pieces of style loss information. The sum of the plurality of pieces of style loss information can be determined as the total style loss information. The weighted sum of the plurality of pieces of identity loss information can be determined as the weighted identity loss information. The sum of the weighted total style loss information and the weighted identity loss information can be determined as the total loss information.

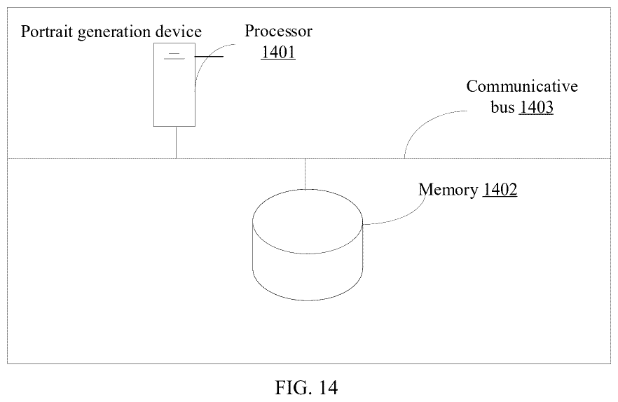

Embodiments of the present disclosure provide a portrait generation device. As shown in FIG. 14, the portrait generation device includes a processor 1401, a memory 1402, and a communication bus 1403.

The communication bus 1403 can be configured to realize a communicative connection between the processor 1401 and the memory 1402.

The processor 1401 can be configured to execute computer programs stored in the memory 1402 to implement the above portrait generation method.

Embodiments of the present disclosure provides the portrait generation device to obtain the original portrait image and the to-be-generated target style information for the original portrait image, extract the identity features from the original portrait image by using the preset portrait generation model to obtain the identity feature information, and perform the plurality of denoising processes on the target style information based on the identity feature information to generate the target portrait image. In the portrait generation device of the present disclosure, the identity features can be extracted from the original portrait image, and the denoising process can be performed on the targe style information based on the identity feature information to generate the target portrait image having the consistent facial appearance as the original portrait image and automatically transferring the target style information. The quality of the portrait generation can be improved.

Embodiments of the present disclosure provide a computer-readable storage medium. The computer-readable storage medium stores one or more computer programs that, when executed by one or more processors, cause the one or more processors to implement the above portrait generation method. The computer-readable storage medium can include a volatile memory, such as a Random-Access Memory (RAM), or a non-volatile memory, such as a Read-Only Memory (ROM), flash memory, hard disk drive (HDD), or solid-state drive (SSD), or a device including one or a combination thereof, such as a mobile phone, computer, tablet device, personal digital assistant, etc.

Those skilled in the art should understand that embodiments of the present disclosure can be provided as a method, system, or computer program product. Therefore, the present disclosure can be implemented as a hardware embodiment, a software embodiment, or an embodiment combining both software and hardware. Moreover, the present disclosure can be implemented as a computer program product that is implemented on one or more computer-usable storage media (including but not limited to a magnetic disk storage, an optical storage, etc.) containing computer-usable program codes.

The present disclosure is described with reference to flowcharts and/or block diagrams of methods, devices (systems), and computer program products according to embodiments of the present disclosure. Each process or block in the flowcharts and/or block diagrams and combinations of processes and/or blocks in the flowcharts and/or block diagrams can be implemented by computer program instructions. The computer program instructions can be provided to a processor of a general-purpose computer, special-purpose computer, embedded processor, or other programmable data processing device to produce a machine to cause the instructions executed by the processor of the computer or other programmable data processing device to create an apparatus for implementing functions specified in the one or more processes of the flowchart and/or the one or more blocks of the block diagram.

The computer program instructions can also be stored in a computer-readable memory that can direct a computer or other programmable data processing device to function in a particular manner such that the instructions stored in the computer-readable memory produce an article of manufacture including instruction means which implement the function specified in the one or more processes of the flowchart and/or the one or more blocks of the block diagram.

The computer program instructions can also be loaded onto the computer or another programmable data processing device to cause a series of operation steps to be performed on the computer or another programmable device to produce a computer-implemented process. Thus, the instructions executed on the computer or another programmable device can provide the steps for implementing the functions specified in one process or more processes of the flowchart and/or in one block or more blocks of the block diagram.

The above are some embodiments of the present disclosure. However, the scope of the present disclosure is not limited here. Those skilled in the art can easily think of modifications or replacements within the technical scope of the present disclosure. These modifications and replacements are within the scope of the present disclosure. Thus, the scope of the present disclosure is subject to the scope of the appended claims.

What is claimed is:

1. A portrait generation method comprising:
obtaining an original portrait image and target style information for the original portrait image; and
performing identity feature extraction on the original portrait image using a preset portrait generation model to obtain identity feature information, and performing a plurality of denoising processes on an initial noise image based on the identity feature information and the target style information to generate a target portrait image.

2. The method according to claim 1, wherein:
the preset portrait generation model includes a plurality of denoising networks connected in sequence, and each denoising network is connected to a corresponding identity feature fusion network; and
performing the plurality of denoising processes on the initial noise image based on the identity feature information and the target style information to generate the target portrait image includes:
inputting the target style information and the initial noise image into a first denoising network of the plurality of denoising networks for denoising to obtain corresponding output information;
for each denoising network, fusing the corresponding output information and the identity feature information using the corresponding identity feature fusion network to obtain corresponding fusion information, and inputting the corresponding fusion information into a next denoising network for denoising to obtain output information corresponding to the next denoising network; and
decoding corresponding fusion information of a last denoising network of the plurality of denoising networks to obtain the target portrait image.

3. The method according to claim 2, wherein:
the identity feature fusion network includes a plurality of fusion units connected in sequence; and
for each denoising network, fusing the corresponding output information and the identity feature information using the corresponding identity feature fusion network to obtain corresponding fusion information includes:
for each denoising network, fusing the corresponding output information and the identity feature information multiple times using the plurality of corresponding fusion units to obtain the corresponding fusion information;
wherein:
an input of a first fusion unit of the plurality of fusion units is the output information of the corresponding denoising network; and
an output of each fusion unit and the identity feature information are used as an input of a next fusion unit.

4. The method according to claim 1, further comprising:
obtaining a trained standard portrait generation model and a to-be-trained portrait generation model including an identity feature fusion network; and
using the standard portrait generation model as a teacher network for self-supervised style feature training, and training the to-be-trained portrait generation model that is used as a student network to obtain the preset portrait generation model.

5. The method according to claim 4, wherein using the standard portrait generation model as the teacher network for self-supervised style feature training, and training the to-be-trained portrait generation model that is used as the student network to obtain the preset portrait generation model includes:
obtaining a sample portrait image and style sample information for the sample portrait image, and performing identity feature extraction on the sample portrait image using the to-be-trained portrait generation model to obtain sample identity feature information;
performing the plurality of denoising processes on the initial noise image based on the style sample information using the standard portrait generation model, and decoding information obtained by each denoising process to obtain a plurality of corresponding standard images;
performing the plurality of denoising processes on the initial noise image based on the sample identity feature information and the style sample information using the to-be-trained portrait generation model, and decoding the information obtained by each denoising process to obtain a plurality of corresponding sample images; and
calculating total loss information between the plurality of standard images and the plurality of sample images, and adjusting model parameters of the to-be-trained portrait generation model based on the total loss information to obtain the preset portrait generation model.

6. The method according to claim 5, wherein calculating the total loss information between the plurality of standard images and the plurality of sample images includes:
performing identity feature extraction on the plurality of sample images to obtain a plurality of pieces of corresponding feature information;
determining identity loss information between the plurality of pieces of feature information and the sample identity feature information to obtain a plurality of pieces of corresponding identity loss information;
performing intermediate feature extraction on the plurality of sample images and the plurality of standard images to obtain a plurality of corresponding multilayer sample intermediate features and a plurality of multilayer standard intermediate features;
determining style loss information between each piece of multilayer sample intermediate feature information of a plurality of pieces of multilayer sample intermediate feature information and corresponding multilayer standard intermediate feature information of a plurality of pieces of multilayer standard intermediate feature information to obtain a plurality of pieces of corresponding style loss information; and
determining the total loss information based on the plurality of pieces of identity loss information and the plurality of pieces of style loss information.

7. The method according to claim 6, wherein determining the total loss information based on the plurality of pieces of identity loss information and the plurality of pieces of style loss information includes:
determining a sum of the plurality of pieces of style loss information as total style loss information, and determining a weighted sum of the plurality of pieces of identity loss information as weighted identity loss information; and
determining a sum of a weight of the total style loss information and weighted identity loss information as the total loss information.

8. A portrait generation apparatus comprising:
an acquisition module configured to obtain an original portrait image and target style information for the original portrait image; and
a processing module configured to perform identity feature extraction on the original portrait image using a preset portrait generation model to obtain identity feature information, and perform a plurality of denoising processes on an initial noise image based on the identity feature information and the target style information to generate a target portrait image.

9. The apparatus according to claim 8, wherein:
the preset portrait generation model includes a plurality of denoising networks connected in sequence, and each denoising network is connected to a corresponding identity feature fusion network; and
the processing module is further configured to:
input the target style information and the initial noise image into a first denoising network of the plurality of denoising networks for denoising to obtain corresponding output information;
for each denoising network, fuse the corresponding output information and the identity feature information using the corresponding identity feature fusion network to obtain corresponding fusion information, and input the corresponding fusion information into a next denoising network for denoising to obtain output information corresponding to the next denoising network; and
decode corresponding fusion information of a last denoising network of the plurality of denoising networks to obtain the target portrait image.

10. The apparatus according to claim 8, wherein:
the identity feature fusion network includes a plurality of fusion units connected in sequence; and
for each denoising network, fusing the corresponding output information and the identity feature information using the corresponding identity feature fusion network to obtain corresponding fusion information includes:
for each denoising network, fusing the corresponding output information and the identity feature information multiple times using the plurality of corresponding fusion units to obtain the corresponding fusion information;
wherein:
an input of a first fusion unit of the plurality of fusion units is the output information of the corresponding denoising network; and
an output of each fusion unit and the identity feature information are used as an input of a next fusion unit.

11. The apparatus according to claim 8, wherein:
the acquisition module is further configured to obtain a trained standard portrait generation model and a to-be-trained portrait generation model including an identity feature fusion network; and
the processing module is further configured to use the standard portrait generation model as a teacher network for self-supervised style feature training, and train the to-be-trained portrait generation model that is used as a student network to obtain the preset portrait generation model.

12. The apparatus according to claim 11, wherein:
the acquisition module is further configured to obtain a sample portrait image and style sample information for the sample portrait image, and perform identity feature extraction on the sample portrait image using the to-be-trained portrait generation model to obtain sample identity feature information; and
the processing module is further configured to:
perform the plurality of denoising processes on the initial noise image based on the style sample information using the standard portrait generation model, and decode information obtained by each denoising process to obtain a plurality of corresponding standard images;
perform the plurality of denoising processes on the initial noise image based on the sample identity feature information and the style sample information using the to-be-trained portrait generation model, and decoding the information obtained by each denoising process to obtain a plurality of corresponding sample images; and
calculate total loss information between the plurality of standard images and the plurality of sample images, and adjust model parameters of the to-be-trained portrait generation model based on the total loss information to obtain the preset portrait generation model.

13. The apparatus according to claim 12, wherein the processing module is further configured to:
perform identity feature extraction on the plurality of sample images to obtain a plurality of pieces of corresponding feature information;
determine identity loss information between the plurality of pieces of feature information and the sample identity feature information to obtain a plurality of pieces of corresponding identity loss information;
perform intermediate feature extraction on the plurality of sample images and the plurality of standard images to obtain a plurality of corresponding multilayer sample intermediate features and a plurality of multilayer standard intermediate features;
determine style loss information between each piece of multilayer sample intermediate feature information of a plurality of pieces of multilayer sample intermediate feature information and corresponding multilayer standard intermediate feature information of a plurality of pieces of multilayer standard intermediate feature information to obtain a plurality of pieces of corresponding style loss information; and
determine the total loss information based on the plurality of pieces of identity loss information and the plurality of pieces of style loss information.

14. The apparatus according to claim 13, wherein the processing module is further configured to:
determine a sum of the plurality of pieces of style loss information as total style loss information, and determining a weighted sum of the plurality of pieces of identity loss information as weighted identity loss information; and
determine a sum of a weight of the total style loss information and weighted identity loss information as the total loss information.

15. The apparatus according to claim 8, wherein:
the preset portrait generation model is obtained by training a to-be-trained portrait generation model including an identity feature fusion network based on a trained standard portrait generation model that is used as a teacher network for self-supervised style feature training;
the standard portrait generation model is configured to perform a plurality of denoising processes on the initial noise image based on the style sample information, and decode information obtained by each denoising process to obtain a plurality of corresponding standard images;
the to-be-trained portrait generation model is configured to perform the plurality of denoising processes on the initial noise image based on the sample identity feature information and the style sample information, and decode the information obtained by each denoising process to obtain a plurality of corresponding sample images; and
total loss information between the plurality of standard images and the plurality of sample images is calculated, and model parameters of the to-be-trained portrait generation model are adjusted based on the total loss information to obtain the preset portrait generation model.

16. A portrait generation device comprising:
one or more processors;
one or more memories storing a computer program that, when executed by the one or more processors, causes the one or more processors to:
obtain an original portrait image and target style information for the original portrait image; and
perform identity feature extraction on the original portrait image using a preset portrait generation model to obtain identity feature information, and perform a plurality of denoising processes on an initial noise image based on the identity feature information and the target style information to generate a target portrait image; and
a communication bus configured to realize a communicative connection between the one or more processors and the one or more memories.

17. The device according to claim 16, wherein:
the preset portrait generation model includes a plurality of denoising networks connected in sequence, and each denoising network is connected to a corresponding identity feature fusion network; and
the one or more processors are further configured to:
input the target style information and the initial noise image into a first denoising network of the plurality of denoising networks for denoising to obtain corresponding output information;
for each denoising network, fuse the corresponding output information and the identity feature information using the corresponding identity feature fusion network to obtain corresponding fusion information, and input the corresponding fusion information into a next denoising network for denoising to obtain output information corresponding to the next denoising network; and
decode corresponding fusion information of a last denoising network of the plurality of denoising networks to obtain the target portrait image.

18. The device according to claim 17, wherein:
the identity feature fusion network includes a plurality of fusion units connected in sequence; and
the one or more processors are further configured to:
for each denoising network, fuse the corresponding output information and the identity feature information multiple times using the plurality of corresponding fusion units to obtain the corresponding fusion information;
wherein:
an input of a first fusion unit of the plurality of fusion units is the output information of the corresponding denoising network; and
an output of each fusion unit and the identity feature information are used as an input of a next fusion unit.

19. The device according to claim 16, wherein the one or more processors are further configured to:
obtain a trained standard portrait generation model and a to-be-trained portrait generation model including an identity feature fusion network; and
use the standard portrait generation model as a teacher network for self-supervised style feature training, and train the to-be-trained portrait generation model that is used as a student network to obtain the preset portrait generation model.

20. The device according to claim 19, wherein the one or more processors are further configured to:
obtain a sample portrait image and style sample information for the sample portrait image, and perform identity feature extraction on the sample portrait image using the to-be-trained portrait generation model to obtain sample identity feature information;
perform the plurality of denoising processes on the initial noise image based on the style sample information using the standard portrait generation model, and decode information obtained by each denoising process to obtain a plurality of corresponding standard images;
perform the plurality of denoising processes on the initial noise image based on the sample identity feature information and the style sample information using the to-be-trained portrait generation model, and decode the information obtained by each denoising process to obtain a plurality of corresponding sample images; and
calculate total loss information between the plurality of standard images and the plurality of sample images, and adjust model parameters of the to-be-trained portrait generation model based on the total loss information to obtain the preset portrait generation model.
